(19) United States
(12) Patent Application Publication
(10) Pub. No.: US 2019/0057471 A1
(43) Pub. Date: Feb. 21, 2019

(54) Student data aggregation system

(71) Applicant: The Power Player Inc., Buffalo, NY (US)

(72) Inventors: David E. MASON, Barrington, IL (US); Kevin KRUEGER, Bay Village, OH (US); Steven M. KULL, Hamburg, NY (US); Brendan J. STAUB, Grand Island, NY (US); Joseph P. GANNON, Buffalo, NY (US)

(21) Appl. No.: 15/998,590

(22) Filed: Aug. 15, 2018

Related U.S. Application Data
(63) Continuation of application No. 15/169,616, filed on May 31, 2016, now abandoned.
(60) Provisional application No. 62/168,780, filed on May 30, 2015.

(51) Int. Cl. G06Q 50/20; G06F 17/30

(52) U.S. Cl. CPC G06Q 50/205; G06F 17/30554

(57) ABSTRACT

A student data aggregation system is a single point for collection, aggregation, visualization and selective distribution of quantitative and qualitative student related data. The system includes facilitating the plurality of students and a plurality of stake-holders to enter qualitative and quantitative student related information on a web-based platform, collecting the qualitative and quantitative student related information, analyzing the qualitative and quantitative student related information, aggregating and visualizing the qualitative and quantitative student related information, and selectively distributing the qualitative and quantitative student related information to the plurality of students and the plurality of stake-holders. The system also provides development tools for students, assessment tools for students and keeps the students engaged not only with each other but also with various stake-holders.

### CROSS-REFERENCE TO RELATED APPLICATIONS

This application is a continuation of U.S. patent application Ser. No. 15/169,616, filed May 31, 2016 and entitled “STUDENT DATA AGGREGATION SYSTEM”, which application claims the benefit under 35 U.S.C. § 119(e) of U.S. Provisional Patent Application Ser. No. 62/168,780, filed May 30, 2015, entitled “STUDENT DATA AGGREGATION SYSTEM”, the disclosures of which are herein incorporated by reference.

### TECHNICAL FIELD

The present invention relates generally to a data aggregation system, and more particularly, to the data aggregation system for students and associated stake-holders.

### BACKGROUND

During the last several years, the advancements in technology have had a tremendous impact on our lives. There are various real life scenarios where use of internet, electronics and communication devices such as personal computers, sensing networks and devices, hand-held personal organizers and computerized automotive controls have changed one's daily life. However, there are very few instances where these technological advancements are being efficiently used in education system.

More often than not, a student has to make his/her professional and career decisions based on his personal assessment on various past events. These decisions may turn out to be wrong as these decisions are just based on personal assessment and memory of past events. For example, the student do not have an aggregated data for the grades achieved by him at different stages, his performances in various subjects, his performances in various extra-curricular activities, his personal physical attributes at different stages of his career, and so on. Further, the student does not have a data of various teachers and/or mentors he has studied under. So, he cannot make a judgment about the teacher/mentor who was effective in improving his performance (both academic and non-academic performances) at a particular point of time. In addition, the student does not have any data which he can analyze. So, in absence of any data, the student usually is not able to improve himself and improve both of his academic and non-academic performances. Moreover, the student does not have any data related to other students by which he can take appropriate decisions. For example, the student does not have the data of another student/tutor who has helped him honed his skill and performance by adopting different strategies at a particular point of time. The student receives this information based on knowledge of his known person and/or from people of his fraternity.

In addition, various stake-holders like governing bodies, teachers and/or mentors, private tutors, supervisors, guardians, and the like which play an important role in shaping a student's career do not have access to the data on which they can rely on to take decisions. For example, for selecting a scholarship grant, an administrator may like to know past achievements of the student, the teachers under which the student has studied, his recent academic achievements, his recent achievements in the extra-curricular activities and so on. Similarly, a guardian may like to know some other facts which may help in making a sound judgment to record and analyze the performance of his child at different stages of his career. The stake-holders do not have a single point of viewing and analyzing qualitative and quantitative student related data.

In light of the above stated discussion, there is a need for a method and system which provide a single point for collection, aggregation, visualization and selective distribution of the quantitative and the qualitative student related data.

### SUMMARY

The present invention aims to overcome the above mentioned limitations and other problems associated with the prior art.

The present disclosure provides a student data aggregation for a plurality of students. The student data aggregation system is a single point for collection, aggregation, visualization and selective distribution of quantitative and qualitative student related data. The student data aggregation system includes facilitating the plurality of students and a plurality of stake-holders to enter qualitative and quantitative student related information on a web-based platform, collecting the qualitative and quantitative student related information, analyzing the qualitative and quantitative student related information, aggregating and visualizing the qualitative and quantitative student related information, and selectively distributing the qualitative and quantitative student related information to the plurality of students and the plurality of stake-holders.

In an embodiment of the present disclosure, the student data aggregation system enables the plurality of stake-holders to provide specific comments and suggestions to the plurality of students.

In an embodiment of the present disclosure, the plurality of stake-holders include a plurality of teachers, a plurality of private tutors, a plurality of governing bodies, a plurality of supervisors, a plurality of trainers, a plurality of nutritionists, and guardians of the respective plurality of students.

In an embodiment of the present disclosure, the student data aggregation system provides a chance to the plurality of students to earn profits from his performance. The profits can be scholarships, fee concessions and the like.

In an embodiment of the present disclosure, the student data aggregation system provides motivation and creates community and connection for the plurality of students.

In an embodiment of the present disclosure, the student data aggregation system provides a feedback to the plurality of students based on their academic and non-academic performances.

In an embodiment of the present disclosure, the student data aggregation system provides parameters for measuring strengths, weakness and progress of each of the plurality of students.

### BRIEF DESCRIPTION OF THE FIGURES

Having thus described the invention in general terms, reference will now be made to the accompanying drawings, which are not necessarily drawn to scale, and wherein:

FIG. 1 illustrates a student data aggregation system, in accordance with various embodiments of the present disclosure;

FIG. 2 illustrates a block diagram of the student data aggregation system, in accordance with various embodiments of the present disclosure; and

FIG. 3 provides a brief general description of a suitable computing environment in which the disclosure can be implemented.

### DETAILED DESCRIPTION

The exemplary embodiments described herein for illustrative purposes are subject to many variations in structure and design. It should be emphasize, however, that the present invention is not limited to method for erasing data from a volatile memory. It is understood that various omissions and substitutions of equivalents are contemplated as circumstances may suggest or render expedient, but these are intended to cover the application or implementation without departing from the spirit or scope of the present invention.

The terms “a” and “an” herein do not denote a limitation of quantity, but rather denote the presence of at least one of the referenced item.

The terms “having”, “comprising”, “including”, and variations thereof signify the presence of a component.

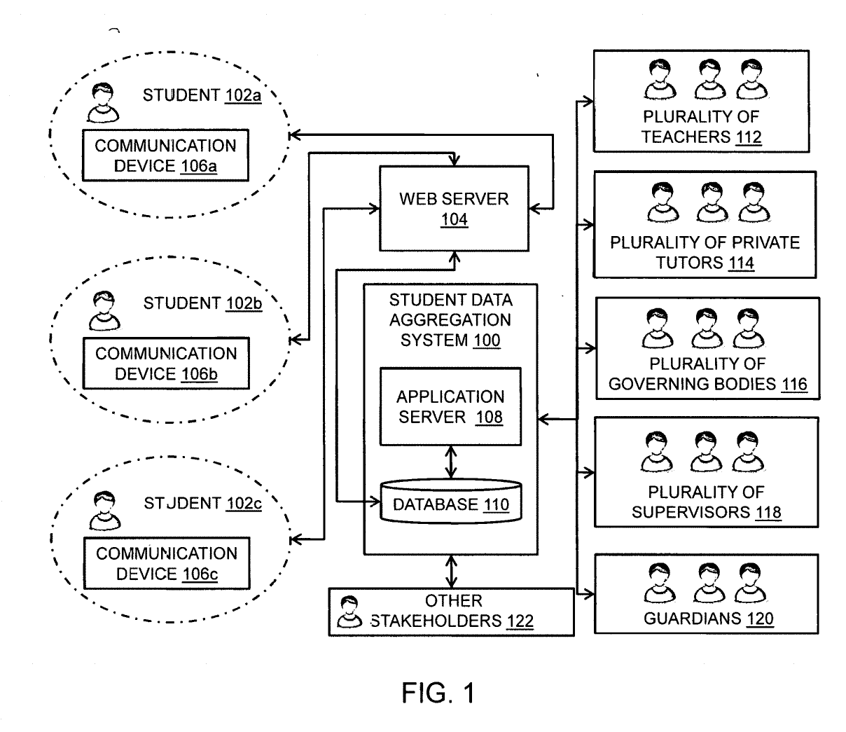

FIG. 1 illustrates a student data aggregation system 100, in accordance with various embodiments of the present disclosure. The student data aggregation system 100 is a single point for collection, aggregation, visualization and selective distribution of quantitative and qualitative student related data. The aggregation, visualization and selective distribution of the quantitative and the qualitative student related data empowers multiple stake-holders to take informed decisions at different stages. In addition, the student data aggregation system 100 provides development tools for students, assessment tools for students and keeps the students engaged not only with each other but also with various stake-holders.

As shown in FIG. 1, a student 102a, a student 102b and a student 102c interacts with the student data aggregation system 100 through a web server 104. The student 102a is associated with a communication device 106a, the student 102b is associated with a communication device 106b and the student 102c is associated with a communication device 106c. In an embodiment of the present disclosure, each of the communication device 106a-c is a portable device. Examples of the communication device 106a-c include but may not be limited to mobile phones, tablets, laptops and the like. Further, each of the communication device 106a-c is associated with the web server 104. In simpler terms, each of the student 102a-c communicates with the web server 104 through the corresponding communication devices 106a-c.

In addition, a plurality of stake-holders 112-122 is associated with the student data aggregation system 100. The plurality of stake-holders 112-122 include a plurality of teachers 112, a plurality of private tutors 114, a plurality of governing bodies 116, a plurality of supervisors 118, guardians 120 and other stake-holders 122. Each of the plurality of stake-holders 112-122 interacts with the student data aggregation system 100 with a corresponding communication device. The student data aggregation system 100 includes an application server 108 and a database 110.

In an embodiment of the present disclosure, the student data aggregation system 100 enables the students 102a-c (or the plurality of students 102a-c) to register on a web-based platform and/or application supported and/or maintained by the student data aggregation system 100 through the corresponding communication devices 106a-c. In another embodiment of the present disclosure, the student data aggregation system 100 enables the guardians 120 of the corresponding students 102a-c to register on the web-based platform and/or the application supported and/or maintained by the student data aggregation system 100 through the corresponding communication devices 106a-c in case the students 102a-c are too small to handle and/or maintain an account. For example, a parent P may register on the web-based platform and/or the application on behalf of her children C1 and C2 who are currently studying in a primary standard.

Further, the student data aggregation system 100 enables the plurality of stake-holders 112-122 to register on the web-based platform and/or application. In an embodiment of the present disclosure, each of the students 102a-c accesses the web-based platform and/or application through the web server 104. Further, the application server 108 runs the web-based platform and/or application.

Further, the student data aggregation system 100 enables the students 102a-c to enter quantitative and qualitative information on the web-based platform and/or application. The student data aggregation system 100 performs a set of operations based on the quantitative and qualitative information entered by the students 102a-c. In an embodiment of the present disclosure, the student data aggregation system 100 enables the students 102a-c to enter the quantitative and qualitative information without registering on the web-based plafform and/or the application. In another embodiment of the present disclosure, the data aggregation system 100 enables the students 102a-c to enter the quantitative and qualitative information by registering on the web-based platform and/or the application.

On the same lines, the student data aggregation system 100 enables the stake-holders 112-122 (the plurality of teachers 112, the plurality of private tutors 114, the plurality of governing bodies 116, the plurality of supervisors 118, the guardians 120 and the other stake-holders 122) to enter the quantitative and qualitative information of the students 102a-c on the web-based platform and/or the application. The plurality of supervisors 118 can be head of departments in institutes, members of management teams of institutes and the like. In an embodiment, the institutes include primary and/or secondary schools, high schools, colleges and the like.

In an embodiment of the present disclosure, the student data aggregation system 100 performs a set of operations based on the quantitative and qualitative information entered by the students 102a-c. In another embodiment of the present disclosure, the student data aggregation system 100 performs a set of operations based on the quantitative and qualitative information entered by the students 102a-c and by the stake-holders 112-122. In an embodiment of the present disclosure, the student data aggregation system 100 enables the stake-holders 112-122 to enter the quantitative and qualitative information of the students 102a-c without registering on the web-based platform and/or application. In another embodiment of the present disclosure, the data aggregation system 100 enables the stake-holders 112-122 to enter the quantitative and qualitative information of the students 102a-c by registering on the web-based platform and/or application.

Further, the student data aggregation system 100 facilitates storing the information and results of the set of operations in the database 110. Moreover, the plurality of stake-holders 112-122 may have access to all or subset of the quantitative and qualitative information of each of the students 102a-c and results of the set of operations performed on the quantitative and qualitative information pertaining to the students 102a-c. In an embodiment of the present disclosure, the quantitative and qualitative information may be aggregated and selective distributed to the stake-holders 112-122 (described later in the application). In an embodiment of the present disclosure, the student data aggregation system 100 charges an amount from the students 102a-c and the plurality of stake-holders 112-122 for establishing and maintaining the account on the web-based platform. The amount can be payable by at least one of following means including online banking, using credit cards, using debit cards and the like. Furthermore, the student data aggregation system 100 generates an id for each of the students 102a-c and each of the stake-holders 112-122 after receiving the payment from each of the students 102a-c and each of the stake-holders 112-122. The id enables the students 102a-c and the stake-holders 112-122 to access the web-based platform. Furthermore, it may be noted that FIG. 1 is shown to include the plurality of stake-holders 112-122 which include the plurality of teachers 112, the plurality of private tutors 114, the plurality of governing bodies 116, the plurality of supervisors 118 the guardians 120 and the other stake-holders 122; however, those skilled in the art would appreciate that there can be lesser or more number of stake-holders. Similarly, it may be noted that in FIG. 1, three students (102a, 102b and 102c) are shown to interact with the student data aggregation system 100; however, those skilled in the art would appreciate that more or lesser number of students can interact with the student data aggregation system 100.

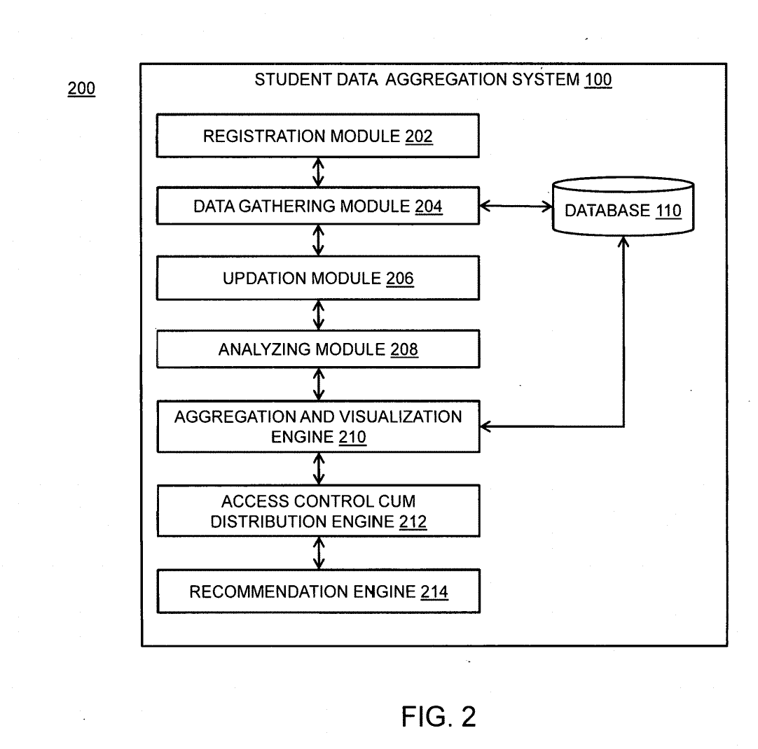

FIG. 2 illustrates a block diagram 200 of the student data aggregation system 100, in accordance with various embodiments of the present disclosure. It may be noted that to explain the system elements of FIG. 2, references will be made to the system elements of the FIG. 1. The block diagram 200 of the student data aggregation system 100 includes a registration module 202, a data gathering module 204, an update module 206, an analyzing module 208, an aggregation and visualization engine 210, an access control cum distribution engine 212, and a recommendation engine 214. Further, the data gathering module 204 is associated with the database 110.

The registration module 202 enables the registration of the students 102a-c on the web-based platform and/or application. Further, the registration module 202 enables registration of each of the stake-holders 112-122 on the web-based platform and/or application. In an embodiment of the present disclosure, the registration module 202 enables the students 102a-c and the stake-holders 112-122 to set up the account on the web-based platform. For setting the account, the students 102a-c and the plurality of the stake-holders 112-122 enters a set of information on the web-based platform and/or application. The information includes but may not be limited to personal information. The personal information includes a first name, a last name, an email id, a password, a phone number, an address, a city name, a state name, a country name, academic information, family background and the like. The students 102a-c and the plurality of the stake-holders 112-122 registers by entering the personal information on the web-based platform.

Moreover, the data gathering module 204 enables each of the students 102a-c to enter a profile information of the students 102a-c and the stake-holders 112-122. The profile information includes a quantitative information and a qualitative information. As mentioned above, the quantitative information includes input metrics, uploaded audios/videos of extra-curricular activities performed by the students 102a-c and the like (described later). The qualitative information includes input ratings, points, comments, messages and the like (described later). In an embodiment of the present disclosure, the students 102a-c enter an academic and a non-academic information. The academic information includes current standard/year of the students 102a-c, grades in each subject in a first set of exams (say, mid-term exams, first semester exams and the like), grades in each subject in a second set of exams (say, final-term exams, second semester exams and the like), an overall grade of the students 102a-c in each subject over a period of years, an overall grade of the students 102a-c over a period of years, favorite subjects, names of institutions and universities under which the students 102a-c has studied or currently studying, names of subject teachers in each standard/year, number of subjects studied in each standard/year and the like.

The non-academic information includes data related to non-academic activities or the extra-curricular activities the students 102a-c has participated in. The extra-curricular activities include but may not be limited to sports, music and dance and dramatics. Further, the non-academic information includes number of the extra-curricular activities performed in the each standard/year, favorite extra-curricular activity, information about inter and intra institution/universities competitions, and the like. In an embodiment of the present disclosure, each of the students 102a-c may enter data related to more than one extra-curricular activity. It may be noted that the scope of the invention is not limited to entering the above stated information as profile information; those skilled in the art would appreciate that each of the students 102a-c may enter other related information as well. In an embodiment of the present disclosure, the guardians 120 may enter the above stated information on behalf of their children (the students 102a-c) on the web-based platform. In another embodiment, the plurality of teachers 112 may enter the above stated information or other information pertaining to the students 102a-c on the web-based platform.

For example, a student X1 studies in a school S1. The student X1 enters his grades obtained in each of the standards, say, A grade in sixth standard, B grade in seventh standard, A grade in eighth standard and so on. Further, the student X1 enters mathematics as his favorite subject. Furthermore, the student X1 is good at dramatics and enters the grades obtained in the dramatics. Similarly, another student X2 studies in a school S2. The student X2 enters his grades obtained in each of the standards, say, B grade in sixth standard, C grade in seventh standard, B grade in eighth standard and so on. Further, the student X2 enters English as his favorite subject. Furthermore, the student X2 is good at gymnastics and enters the grades obtained in the gymnastics.

In another embodiment, each of the students 102a-c enters information including attitude, communication skills, listening skills, grasping power of concepts, rapport with teachers and class mates, competitiveness, mental toughness, calendars/schedules and the like. It may be noted that the scope of the invention should not be limited to enter the profile information; those skilled in the art would appreciate that each of the students 102a-c may enter other related information as well. In an embodiment of the present disclosure, the guardians 120 may enter the above stated information on behalf of their children or any other pertinent information (the students 102a-c) on the web-based platform. In another embodiment, the plurality of teachers 112 may enter the above stated information or any other information of the students 102a-c on behalf of the students 102a-c on the web-based platform.

For example, the student X1 enters a list of his upcoming exams, information related to time devoted for studies, say, a total of 8 hours daily, time devoted for improving the communication skills and the listening skills, say, a total of 1 hour daily, time devoted for improving performance in the dramatics and the like. Similarly, the student X2 enters a list of his upcoming exams, information related to time devoted for studies, say, a total of 6 hours daily, time devoted for improving the communication skills and the listening skills, say, a total of half an hour daily, time devoted for improving performance in the gymnastics and the like.

In yet another embodiment, each of the students 102a-c may upload audios and videos of their performance in the extra-curricular activities. For example, the students X1 and X2 upload their videos of a drama competition and a gymnastics competition respectively. In an embodiment of the present disclosure, the guardians 120 may upload the audios and videos of the performance of their children (the students 102a-c) in the extra-curricular activities on behalf of their children (the students 102a-c) on the web-based platform. In another embodiment, the plurality of teachers 112 may upload the audios and videos of the performance of the students 102a-c in the extra-curricular activities on behalf of the students 102a-c on the web-based platform.

In an embodiment of the present disclosure, the students 102a-c may enter their academic and non-academic achievements. In an embodiment of the present disclosure, the students 102a-c may enter number of awards, certificates, medals and the like achieved by them, both in the academic and the non-academic arenas. In another embodiment of the present disclosure, the students 102a-c give ratings and/or points to themselves based upon their performance in the academic and the non-academic arenas (for example, in a mid-term exam, in a final term exam, in the drama competition and the like). In yet another embodiment, the plurality of teachers 112 teaching the students 102a-c may give the ratings, the points, the comments, the messages to each of the students 102a-c based upon their performance in the academic and the non-academic arenas (for example, in the mid-term exam, in the final term exam, in the drama competition and the like). In yet another embodiment, the plurality of stake-holders 112-122 (the plurality of private tutors 114, the plurality of governing bodies 116, the plurality of supervisors 118 and the guardians 120) may give the ratings, the points, the comments, the messages to each of the students 102a-c based upon their performance in the academic and the non-academic arenas. In yet another embodiment, the students 102a-c may rate a teacher of the plurality of teachers 112 based on their performance under his/her role and guidance. In yet another embodiment, the guardians 120 may provide the comments to their children (the students 102a-c) regarding their performance in the in the academic and the non-academic arenas.

Further, the guardians 120 may provide feedback regarding each of the plurality of teachers 112. In an embodiment of the present disclosure, the guardians 120 may give comments to the plurality of teachers 112. In another embodiment of the present disclosure, the guardians 120 may give comments to the plurality of private tutors 114. For example, a guardian G1 thinks that under a private tutor T1, the performance of their child (say, the student 102a) has gone below a suitable mark, and thus rates the private tutor T1 very low. On the other hand, the same guardian G1 thinks that under a private tutor T2, the performance of their child (say, the student 102a) has further increased, and thus rates the private tutor T2 very high. In yet another embodiment, the guardians 120 may file a complaint against any teacher of the plurality of teachers 112. In this case, the plurality of governing bodies 116 and the plurality of supervisors 118 can communicate and try to resolve the case.

Further, in an embodiment of the present disclosure, the students 102a-c and the plurality of stake-holders 112-122 may give the ratings by simply writing one or more values. In another embodiment, the students 102a-c and the plurality of stake-holders 112-122 may give ratings by choosing from a drop down list (say, a list representing poor, average, good, very good and excellent). In yet another embodiment, the students 102a-c and the plurality of stake-holders 112-122 may give the ratings by using one or more scales. The one or more scales may feature different skills of the students 102a-c. In yet another embodiment, the guardians 120 may give comments to the students 102a-c based on their performances. It may be noted that various rating tools (described above) are provided to rate the students 102a-c based on their skills; however, those skilled in the art would appreciate that more rating tools may be provided to rate the students 102a-c.

In an embodiment of the present disclosure, each of the students 102a-c may have permissions to view each other's profile. Further, each of the students 102a-c may provide the ratings and the comments to each other.

Further, the data gathering module 204 collects the information and the data described above and stores it in the database 110. Further, the data gathering module 204 collects and maintains a repository of the collected information in the database 110. In an embodiment of the present disclosure, each of the students 102a-c may redeem the points obtained/earned by them. For example, the points obtained/earned by each of the students 102a-c may be redeemed for obtaining fee concessions. In an embodiment of the present disclosure, the data gathering module 204 collects the quantitative and qualitative information from third party sources such as web, third party database, or any other source.

Further, the update module 206 enables an automatic update of the stored information in the database 110 whenever any additional information is entered by each of the students 102a-c and the stake-holders 112-122. In simpler terms, with each additional information entered by each of the students 102a-c and the stake-holders 112-122, the database 110 gets updated at regular intervals of time. In an embodiment of the present disclosure, previously stored records are also maintained for future references. In other words, the database 110 is dynamic and updated on periodic basis.

For example, the student X1 has updated his new house address and name of his school on the web-based platform, the same gets updated in the database 110 as well. In another example, the student X2 uploads a video showing his performance in the gymnastics tournament, or enters a change in the diet plan on the web-based platform. The update module 206 updates these changes in the database 110 as well.

The analyzing module 208 analyzes both the quantitative and qualitative data uploaded and/or entered by each of the students 102a-c. In an embodiment of the present disclosure, the analyzing module 208 analyzes performance of each of the students 102a-c in both the academic and the non-academic arenas in a period of time, say, in a year, last five months, last five years and the like. In another embodiment, the analyzing module 208 analyzes performance of the students 102a-c under a specific teacher/mentor and performance of the students 102a-c affected due to changes in the study plan, playing hours, sleep hours and the like.

Continuing with the above stated example, the analyzing module 208 analyzes that student X1 has scored better grades under guidance of his new teacher ‘A’ rather than his previous teacher ‘B’. Further, the analyzing module 208 analyzes that student X1 has scored better grades under guidance of his new private tutor ‘T’ rather than his previous private tutor ‘Y’. Furthermore, the analyzing module 208 analyzes that the performance of the student X1 in the dramatics has improved in last 3 months by changing his practice plan, while the performance of the student X2 in the gymnastics has degraded in last few months by changing his exercise plan. In addition, the analyzing module 208 analyzes that student X2 has scored slightly poor grades under guidance of his new teacher ‘A1’ rather than his previous teacher ‘B1’. Further, the analyzing module 208 analyzes that student X2 has scored better grades in English under guidance of his new English teacher rather than his previous English teacher.

The aggregation and visualization engine 210 aggregates the analyzed information at one place. The analyzed information includes analysis of both the quantitative and qualitative data. Further, the aggregation and visualization engine 210 stores the aggregated information in the database 110. The aggregated information includes a collective data that influences the performance of the students 102a-c both in the academic and the non-academic arenas. For example, a data (say, a change in self-study hours, a change in the sleep hours and the like) representing a positive impact on the performance of the student X1 in his studies is aggregated at a place and a data that leads to a negative impact on the performance of the student X1 in his studies is aggregated at another place. Similarly, a data (say, a change in self-study hours, a change in the sleep hours and the like) representing a positive impact on the performance of the student X2 in his studies is aggregated at a place and a data that leads to a negative impact on the performance of the student X2 in his studies is aggregated at another place.

In an embodiment of the present disclosure, the aggregation and visualization engine 210 aggregates performance of the students 102a-c over a period of time, say a month, a year, last 5 years and the like. In another embodiment, the aggregation and visualization engine 210 aggregates performance of the students 102a-c under guidance of the teacher/mentor and the plurality of teachers 112.

Further, the aggregation and visualization engine 210 generates and/or maintains pictorial representations and reports based on the analyzed and the aggregated information. The analyzed and the aggregated information can be pictorially represented as mountains, spiders, graphs, pie charts and the like. In an embodiment of the present disclosure, the pictorial representation illustrates the academic performance of the students 102a-c in a month, year or in last five years. In another embodiment, the pictorial representation illustrates the non-academic performance of the students 102a-c in the month, year or in last five years. In yet another embodiment, the pictorial representation illustrates the performance of the students 102a-c in a subject. In yet another embodiment, the pictorial representation illustrates the performance of the students 102a-c in one or more subjects. In yet another embodiment, the pictorial representation illustrates different skills of the students 102a-c in an extra-curricular activity. In yet another embodiment, the pictorial representation illustrates different skills of the students 102a-c in one or more extra-curricular activities.

Further, the pictorial representations may help the students 102a-c and the plurality of stake-holders 112-122 to further give the ratings, the comments, the points and the like.

In an embodiment of the present disclosure, the access control cum distribution engine 212 enables displaying of a set of the quantitative and qualitative information, the analyzed quantitative and qualitative information and the aggregated quantitative and qualitative information to each of the plurality of stake-holders 112-122. For example, the guardians 120 will be able to view one set of quantitative and qualitative information, the analyzed quantitative and qualitative information and the aggregated quantitative and qualitative information of the students 102a-c. The plurality of teachers 112 will be able to view another set of quantitative and qualitative information, the analyzed quantitative and qualitative information and the aggregated quantitative and qualitative information. In an embodiment of the present disclosure, each of the students 102a-c will be able to view a sub-set of the quantitative and qualitative information, the analyzed quantitative and qualitative information and the aggregated quantitative and qualitative information. For example, the student 102a may be able to view the ratings provided by his teacher but may not be able to view the comments made by the plurality of governing bodies 116.

In an embodiment of the present disclosure, an administrator of the student data aggregation system 100 sets the policies and permission for accessing the information for each of the students 102a-c and the plurality of stake-holders 112-122. In another embodiment, the access control cum distribution engine 212 enables each of the students 102a-c to restrict displaying and accessing of the set of information, the profile information, the analyzed and the aggregated information to the plurality of stake-holders 112-122. In yet another embodiment, the access control cum distribution engine 212 enables each of the students 102a-c to restrict and/or display the set of quantitative and qualitative information, the analyzed quantitative and qualitative information and the aggregated quantitative and qualitative information to the plurality of stake-holders 112-122.

In an embodiment of the present disclosure, the access control cum distribution engine 212 enables each of the students 102a-c to set a privacy of their respective accounts. In an embodiment of the present disclosure, the recommendation engine 214 recommends each of the students 102a-c to make changes in the number of sleep hours and the self-study hours or to follow a specific time table to manage both academic and non-academic activities simultaneously. In another embodiment of the present disclosure, the recommendation engine 214 recommends the guardians 120 of each of the students 102a-c to change and/or give a specific diet to the corresponding student of the students 102a-c for their better performance in both the academic and non-academic activities. In yet another embodiment of the present disclosure, the recommendation engine 214 recommends the plurality of teachers 112 to follow a specific style of teaching for better performance of the students 102a-c.

In yet another embodiment of the present disclosure, the recommendation engine 214 recommends the plurality of governing bodies 116 and the plurality of supervisors 118 to rank each of the students 102a-c based on the performance analyzed with the help of the pictorial representations. The recommendations are provided based on the analyzed information, the aggregated information, and the pictorial representations. More specifically, the recommendation engine 214 distributes the quantitative data, the qualitative data, the visualized reports, the pictorial representations and the like to the students 102a-c, and the plurality of stake-holders 112-122. Moreover, in an embodiment, the recommendations prove to be useful for the plurality of governing bodies 116 and the plurality of supervisors 118 while deciding a scholarship holder. Further, in another embodiment, the recommendations prove to be useful for the plurality of governing bodies 116 and the plurality of supervisors 118 while deciding mentors for the students 102a-c. For example, if the student X1 is weak in algebra and the pictorial representations suggest that a teacher Y has an excellent past record of improving grades in the algebra, then the recommendation engine 214 may recommend the plurality of supervisors 118 to provide the student X1 a mentor (the teacher Y) for improving his grades.

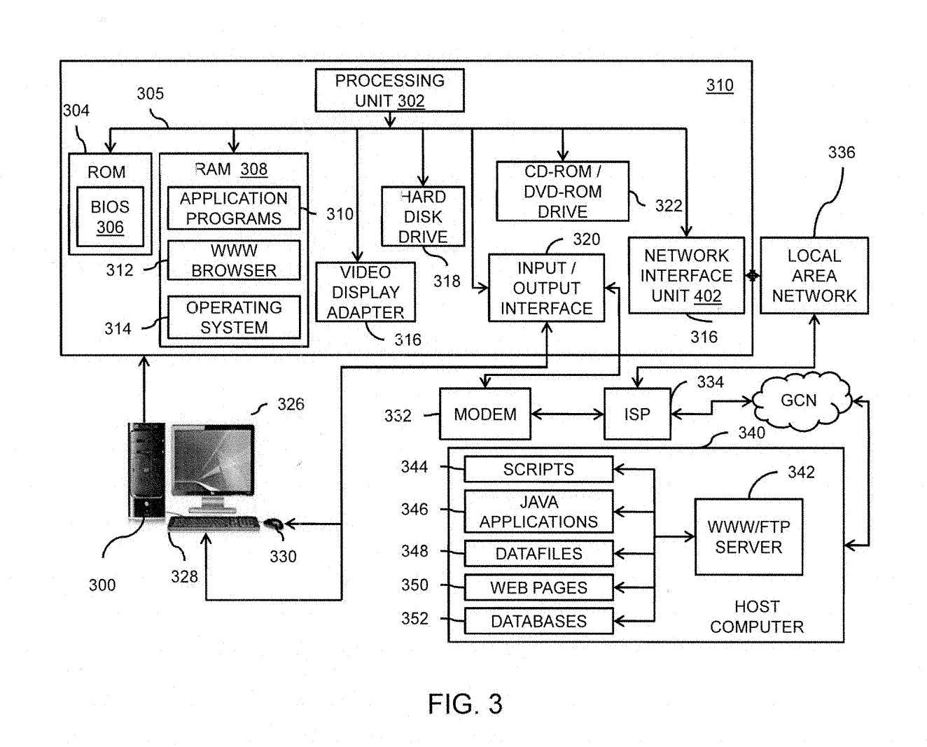

FIG. 3 provides a brief general description of a suitable computing environment in which the disclosure can be implemented. Referring now to FIG. 3, an illustrative environment includes a personal computer 300. The personal computer 300 includes a processing unit 302, a system memory, including read only memory (ROM) 304 and random access memory (RAM) 308, and a system bus 305 that couples the system memory to the processing unit 302. The read only memory (ROM) 304 includes a basic input/output system 306 (BIOS). The basic input/output system 306 contains the basic routines which transfers information between elements within the personal computer 300. Further, the personal computer 300 includes a hard disk drive 318 and an optical disk drive 322. The drives and their associated computer-readable media provide non-volatile storage for the personal computer 300. The non-volatile storage refers to a hard disk, a removable magnetic disk and a CD-ROM or DVD-ROM disk and other similar types of media are readable by a computer. The other type of media storage include magnetic cassettes, flash memory cards, digital video disks, Bernoulli cartridges, and the like. Further, those skilled in the art should appreciate that the personal computer 300 should be broadly interpreted to any machine or device being capable of processing inputs and outputs, calculating results, and in some ways connect to other devices. Examples of the personal computer 300 include but not limited to: personal desktop computers, laptop or notebook, and mobile devices such as iPad, iPhone, Android phone, Android tablet, Blackberry, Blackberry tablet, or any other “smart,” web-enabled cell phones, pocket computers or pocket organizers.

Further, program modules are stored in the drives and RAM 308. The program modules include an operating system 314 and one or more application programs 310. The application programs 310 can be a program for browsing the world-wide-web, such as WWW browser 312.

A user enters commands and information through a keyboard 328 and a pointing device. Examples of the pointing device include but may not be limited to a mouse 330. In addition, the control input devices include a microphone, joystick, game pad, satellite dish, scanner, or the like. These input devices are connected to the processing unit 300 via an input/output interface 320. The input/output interface 320 is coupled to the system bus, but may be connected by other interfaces, such as a game port, universal serial bus, or firewire port.

The personal computer 300 can operate in a networked environment using logical connections to one or more remote computers, such as a host computer 340. Examples of the host computer 340 can be a server, a router, a peer device or other common network node. The networking environments are commonplace in offices, enterprise-wide computer networks, intranets and the GCN.

In general, the host computer 340 includes many or all of the elements of the personal computer 300. The LAN 336 can be connected to a GCN service provider 334 (“ISP”) for access to the GCN 338. In this manner, WWW browser 312 connects to host computer 340 through LAN 336, ISP 334, and the GCN 338. The personal computer 300 is connected to the LAN 336 through a network interface unit 324 when used in a LAN networking environment. The personal computer 300 include a modem 332 or other means for establishing communications through the GCN service provider 334 to the GCN When used in a WAN networking environment. The modem 332 can be internal or external and is connected to the system bus 305 via the input/output interface 320.

In general, the operating system 314 controls the operation of the personal computer 300, including input/output operations. A display monitor 326 or other type of display device is also connected to the system bus 305 via an interface, such as a video display adapter 316. In addition to the monitor, personal computers typically include other peripheral output devices (not shown), such as speakers or printers. The personal computer 300 may be capable of displaying a graphical user interface on monitor 326.

The disclosure can be used in conjunction with Microsoft Corporation's “Windows 98” operating system and a WWW browser 312, such as Microsoft Corporation's GCN EXPLORER, Netscape Corporation's GCN NAVIGATOR, or Mozilla Corporation's GCN FIREFOX, operating under this operating system. Those skilled in the art would appreciate that the disclosure can be implemented for use in other operating systems, such as Microsoft Corporation's “WINDOWS 3.1,” “WINDOWS 95”, “WINDOWS NT”, “WINDOWS 2000”, “WINDOWS XP”, “WINDOWS VISTA”, and “WINDOWS 7” operating systems, IBM Corporation's “OS/2” operating system, SunSoft's “SOLARIS” operating system used in workstations manufactured by Sun Microsystems, and the operating systems used in “MACINTOSH” computers manufactured by Apple Computer, Inc.

In general, the host computer 340 is also connected to the GCN 338, and contains components similar to those contained in personal computer 300. In addition, the host computer 340 can execute an application program for receiving requests for WWW pages, and for serving such pages to the requestor, such as WWW server 342.

The WWW server 342 transmits WWW pages 350 comprising hyper-text markup language (“HTML”) or other markup language files, such as active server pages, to WWW browser 312. Similarly, the WWW server 342 transmits requested data files 348, such as graphical images or text information, to WWW browser 312. The WWW server has the capability to execute scripts 344, such as CGI or PERL scripts, to dynamically produce WWW pages 350 for transmission to WWW browser 312.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present invention.

What is claimed:

1. A student data aggregation system comprising (1) a data gathering module, in a processor, wherein the data gathering module being configured to gather a qualitative and quantitative information corresponding to a plurality of students from the plurality of students and a plurality of stake-holders, wherein the quantitative and qualitative information comprises education related information; (2) an analyzing module, in the processor, wherein the analyzing module being configured to analyze the gathered quantitative and qualitative information corresponding to the plurality of students; (3) an aggregation and visualization engine, in the processor, wherein the aggregation and visualization engine being configured to aggregate and visualize the analyzed qualitative and quantitative information corresponding to the plurality of students; and (4) an access control cum distribution engine, in the processor, wherein the access control cum distribution engine being configured to enable a selective distribution of a set of the gathered quantitative and qualitative information, the analyzed quantitative and qualitative information, and the aggregated quantitative and qualitative information to each of the plurality of stake-holders.

2. The student data aggregation system of claim 1, further comprising a registration module in the processor, wherein the registration module being configured to enable registration of the plurality of students and the plurality of stake-holders.

3. The student data aggregation system of claim 1, further comprising an update module in the processor, wherein the update module being configured to enable an automatic update of a stored information in a database on encountering an additional information.

4. The student data aggregation system of claim 3, wherein the additional information being entered by the plurality of students and the plurality of stake-holders.

5. The student data aggregation system of claim 1, further comprising a recommendation engine in the processor, wherein the recommendation engine being configured to provide a better opportunities to the plurality of students and the plurality of stake-holders.

6. The student data aggregation system of claim 1, wherein the education related information comprises an academic and a non-academic information, wherein the academic information comprises at least one of current standard/year, grades in each subject, an overall grade, favorite subjects, names of institutions and universities under which each of the student has studied or currently studying and names of subject teachers, and wherein the non-academic information comprises at least one of number of extra-curricular activities performed in the each standard/year, favorite extra-curricular activity and information about inter and intra institution/universities competitions.

7. The student data aggregation system of claim 1, wherein the quantitative and qualitative information being visualized by using at least one of mountains, graphs, spiders and pie-charts.

8. The student data aggregation system of claim 1, further comprising a database in the processor, wherein the database being configured to store the gathered quantitative and qualitative information, the analyzed quantitative and qualitative information, and the aggregated quantitative and qualitative information.

9. The student data aggregation system of claim 1, wherein the access control cum distribution engine being further configured to enable each of the plurality of students to set a privacy of their respective accounts on a web-based platform.

10. A computer program product comprising a non-transitory computer readable medium storing a computer readable program, wherein the computer readable program when executed on a computer causes the computer to perform steps comprising (1) gathering a qualitative and quantitative information corresponding to a plurality of students from the plurality of students and a plurality of stake-holders, wherein the qualitative and quantitative information comprises education related information; (2) analyzing the gathered qualitative and quantitative information corresponding to the plurality of students; (3) aggregating and visualizing the analyzed qualitative and quantitative information corresponding to the plurality of students; and (4) selectively distributing a set of the gathered quantitative and qualitative information, the analyzed quantitative and qualitative information, and the aggregated quantitative and qualitative information to each of the plurality of stake-holders.

11. The computer program product of claim 10, wherein the computer readable program when executed on the computer causes the computer to perform a further step of enabling registration of the plurality of students and the plurality of stake-holders.

12. The computer program product of claim 10, wherein the computer readable program when executed on the computer causes the computer to perform a further step of enabling an automatic update of a stored information in a database on encountering an additional information.

13. The computer program product of claim 10, wherein the computer readable program when executed on the computer causes the computer to perform a further step of providing better opportunities to the plurality of students and the plurality of stake-holders.

14. The computer program product of claim 10, wherein the computer readable program when executed on the computer causes the computer to perform a further step of storing the gathered quantitative and qualitative information, the analyzed quantitative and qualitative information, and the aggregated quantitative and qualitative information.

15. The computer program product of claim 10, wherein the computer readable program when executed on the computer causes the computer to perform a further step of enabling each of the plurality of students to set a privacy of their respective accounts on a web-based platform.

16. The computer program product of claim 10, wherein the computer readable program when executed on the computer causes the computer to perform a further step of enabling the plurality of stake-holders to provide specific comments and suggestions to the plurality of students.

17. The computer program product of claim 10, wherein the plurality of stake-holders comprises at least one of a plurality of teachers, a plurality of private tutors, a plurality of governing bodies, a plurality of supervisors and guardians.

18. The computer program product of claim 10, wherein the computer readable program when executed on the computer causes the computer to perform a further step of providing a chance to the plurality of students to earn profits based on their ratings.

19. The computer program product of claim 10, wherein the computer readable program when executed on the computer causes the computer to perform a further step of providing a feedback to the plurality of students and the plurality of stake-holders.

20. The computer program product of claim 10, wherein the computer readable program when executed on the computer causes the computer to perform a further step of providing parameters for measuring strengths, weakness and progress of each of the plurality of students and the plurality of stake-holders.
